(19) United States
(12) Patent Application Publication
(10) Pub. No.: US 2013/0258343 A1
(43) Pub. Date: Oct. 3, 2013

(54) METHOD AND APPARATUS TO IMPROVE SIGNAL-TO-NOISE RATIO OF FT-IR SPECTROMETERS USING PULSED LIGHT SOURCE

(71) Applicants: Miao ZHU, San Jose, CA (US); Robert C. TABER, Palo Alto, CA (US)

(72) Inventors: Miao ZHU, San Jose, CA (US); Robert C. TABER, Palo Alto, CA (US)

(73) Assignee: AGILENT TECHNOLOGIES, INC., Loveland, CO (US)

(21) Appl. No.: 13/435,735

(22) Filed: Mar. 30, 2012

(51) Int. Cl. G01J 3/50; G01N 21/59

(52) U.S. Cl. 356/403; 356/432; 356/402

(57) ABSTRACT

An optical spectroscopy method and apparatus increases signal to noise ratio of detected signals. Sample light passed through a sample includes attenuated light pulses and characteristic light located between the attenuated light pulses, the characteristic light formed by interaction between light pulses incident the sample and sample molecules. The attenuated light pulses are substantially removed from the sample light emerging from the sample prior to detection, to increase signal to noise ratio of the detected signal.

### BACKGROUND

Spectroscopy methods using coherent pulse light sources can greatly improve molecular detection sensitivity. For example, cavity enhanced spectroscopy using a mode-locked laser pumped optical parametric oscillator (OPO) in the mid-infrared (Mid-IR) wavelength range provides an absorption length of several kilometers and a detection sensitivity better than 1 part per billion (ppb).

FIG. 1A is a diagram illustrating a pulse train output from a pulsed light source in the time domain, useful for spectroscopy. In a typical case, the pulse width of light pulses 101 may be less than 1 picosecond (ps), and the time interval between light pulses 101 may be about 10 nanoseconds (ns), for example. In the frequency domain, the output of the coherent pulse source consists of a large number of evenly spaced frequency components. The initial phases of these frequency components are aligned so that these frequency components cancel each other in the time interval between two adjacent light pulses 101. There is essentially no light between adjacent light pulses 101.

FIG. 1B is a diagram illustrating the pulse train of FIG. 1A after passing through a sample. Upon passing through the sample, some frequency components of the pulse train which are in the vicinity of transitions of the sample molecules are partially attenuated and/or phase shifted. The attenuation and phase shift due to interaction with the sample molecules alter the condition of cancellation in the time interval between the pulses. As a result, signals 105 having relatively small intensity are formed in the time interval between adjacent attenuated light pulses 103 due to sample absorption, as shown in FIG. 1B. It is these signals 105 of relatively small intensity that are useful to reveal the characteristics of the sample molecules.

The combination of a scanning Michelson interferometer followed by a square-law detector may be used to detect and analyze various frequency components in the optical fields emerging from a sample. The photocurrent vs. interferometer arm difference measured by the paired interferometer/detector, an interferogram, may be Fourier transformed to provide a power spectrum of the optical fields input to the interferometer. The absorption of the sample may be obtained by taking the difference of the power spectra with and without the sample. Other methods may also be used to detect and analyze the optical fields emerging from a sample. These methods may include a combination of a virtual image phase array, a grating, and a camera, an echelle spectrometer, and a combination of a dispersive material (e.g., a long optical fiber) and a (fast) photo-detector.

However, since the average optical power within the attenuated light pulses 103 of the pulse train emerging from the sample is much larger than the average optical power of the signals 105 of relatively small intensity between attenuated light pulses 103 as shown in FIG. 1B, power fluctuations in light pulses 103 caused by the power fluctuations in light pulses 101 output from the coherent pulse source can reduce the signal to noise ratio of the detected signal. In vapor phase spectroscopy in particular, pulse power fluctuations can significantly reduce signal to noise ratio of the detected signal, because the absorption lines can be quite weak.

There is therefore a need to provide improved spectroscopy methods, useful with pulsed light sources, that can increase the signal to noise ratio of absorption signals.

### SUMMARY

In a representative embodiment, a method includes passing light pulses through a sample to provide sample light, the sample light comprising attenuated light pulses, and characteristic light formed by interaction between the light pulses and sample molecules, wherein the characteristic light is located between the attenuated light pulses; substantially removing the attenuated light pulses from the sample light; and detecting the characteristic light from the sample light after removing the attenuated light pulses.

In a further representative embodiment, an optical spectrometer includes an optical component configured to receive sample light comprising attenuated light pulses, and characteristic light formed by interaction between light pulses incident on a sample and sample molecules, wherein the characteristic light is located between the attenuated light pulses, the optical component further configured to substantially remove the attenuated light pulses from the sample light; and a detector configured to detect the characteristic light from the sample light after removal of the attenuated light pulses.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIGS. 1A and 1B are diagrams respectively illustrating a pulse train output from a pulsed light source in the time domain, and the pulse train of FIG. 1A after passing through a sample.

FIG. 2 is a block diagram illustrating an optical spectrometer 10, according to a representative embodiment.

FIG. 3 is a block diagram illustrating an optical spectrometer 20, according to a representative embodiment.

FIG. 4 is a block diagram illustrating an optical spectrometer 30, according to a representative embodiment.

FIG. 5 is a block diagram illustrating an optical spectrometer 40, according to a representative embodiment.

FIG. 6 is a block diagram illustrating an optical spectrometer 50, according to a representative embodiment.

FIGS. 7A-7D are diagrams respectively illustrating a pulse train after passing through sample 530, auxiliary light generated by auxiliary light source 532, attenuated light pulses 103 output from non-linear optical crystal 534, and converted characteristic light 505 which has been mixed with the auxiliary light by non-linear optical crystal 534 of optical spectrometer 50.

FIGS. 8A-8D are diagrams respectively illustrating a pulse train after passing through sample 530, auxiliary light generated by auxiliary light source 532, attenuated light pulses 103 and portions of characteristic light 105 output from non-linear optical crystal 534, and converted characteristic light 613 which has been mixed with auxiliary light by non-linear optical crystal 534 of optical spectrometer 50, according to a further representative embodiment.

FIGS. 9A-9D are diagrams respectively illustrating a pulse train after passing through sample 530, auxiliary light generated by auxiliary light source 532, converted attenuated light pulses 703 which have been mixed with the auxiliary light by non-linear optical crystal 534, and characteristic light 105 output from non-linear optical crystal 534 of optical spectrometer 50, according to a still further representative embodiment.

FIGS. 10A-10C are diagrams respectively illustrating a pulse train after passing through sample 430 of FIG. 5, control signal 407, and portions of characteristic light 419 output from intensity modulator 440, according to another representative embodiment.

### DETAILED DESCRIPTION

In the following detailed description, for purposes of explanation and not limitation, illustrative embodiments disclosing specific details are set forth in order to provide a thorough understanding of embodiments according to the present teachings. However, it will be apparent to one having had the benefit of the present disclosure that other embodiments according to the present teachings that depart from the specific details disclosed herein remain within the scope of the appended claims. Moreover, descriptions of well-known devices and methods may be omitted so as not to obscure the description of the example embodiments. Such methods and devices are within the scope of the present teachings.

Generally, it is understood that as used in the specification and appended claims, the terms “a”, “an” and “the” include both singular and plural referents, unless the context clearly dictates otherwise. Thus, for example, “a device” includes one device and plural devices.

As used in the specification and appended claims, and in addition to their ordinary meanings, the terms “substantial” or “substantially” mean to within acceptable limits or degree. For example, “substantially cancelled” means that one skilled in the art would consider the cancellation to be acceptable. As a further example, “substantially removed” means that one skilled in the art would consider the removal to be acceptable.

As used in the specification and the appended claims and in addition to its ordinary meaning, the term “approximately” means to within an acceptable limit or amount to one having ordinary skill in the art. For example, “approximately the same” means that one of ordinary skill in the art would consider the items being compared to be the same.

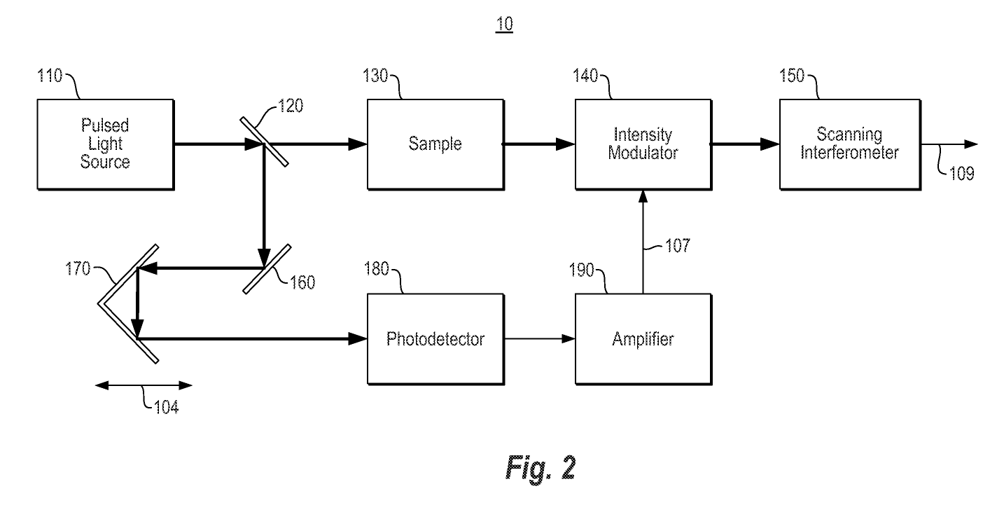

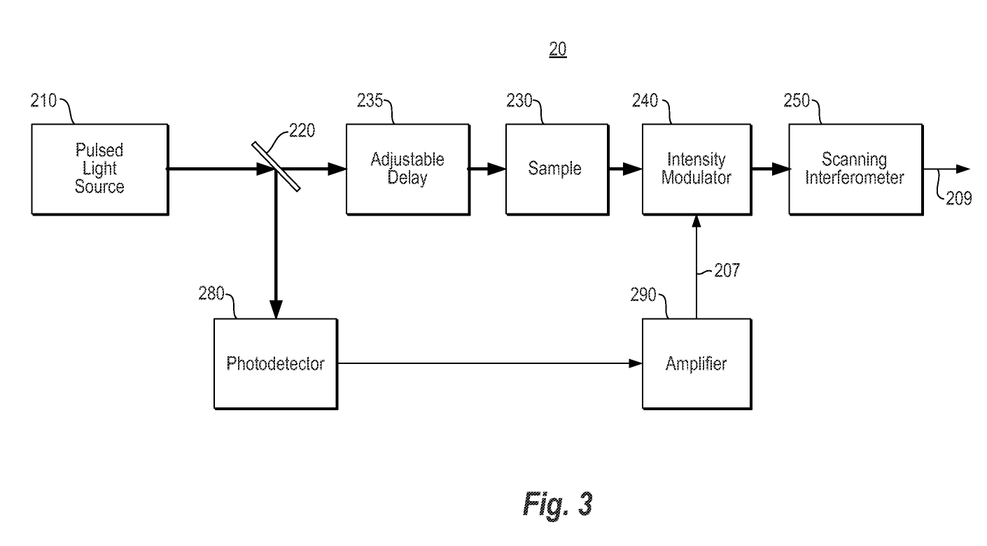

FIG. 2 is a block diagram illustrating optical spectrometer 10, according to a representative embodiment. In FIG. 2, and similarly in FIGS. 3-6 that follow, the thicker arrows indicate optical (light) signals, and the thinner arrows indicate electrical signals, unless specified otherwise.

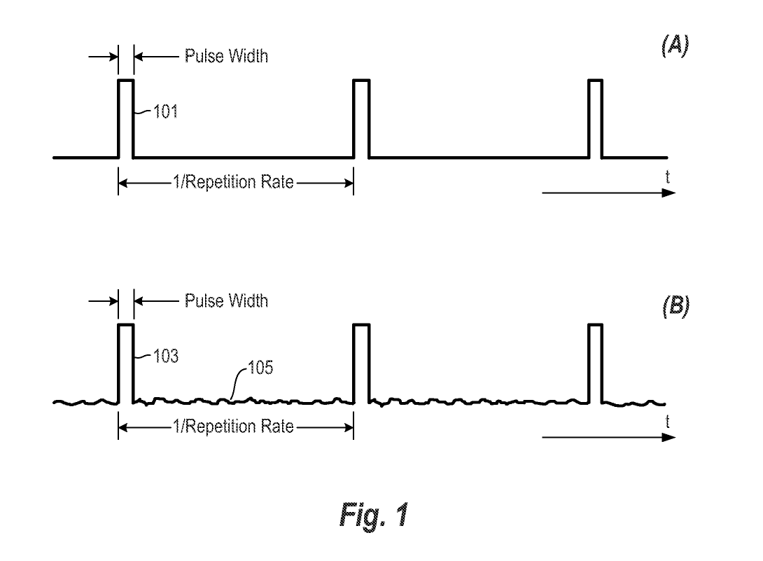

Pulsed light source 110 in FIG. 2 generates a pulse train such as shown in FIG. 1A that includes light pulses 101 having a pulse width that may be less than about 1 picosecond (ps) and a pulse interval, which is the reciprocal of the repetition rate of the pulse train, that may be about 10 nanoseconds (ns), for example. The values of pulse width and pulse interval as described are given by way of example, and it should be understood that pulse trains having other values of pulse width and pulse interval may be used. However, pulse width is typically much shorter than the pulse interval. Pulsed light source 110 may be a pulsed laser, a mode-locked laser or a Q-switched laser, for example.

The pulse train including light pulses 101 as generated by pulsed light source 110 in FIG. 2 are output to beam splitter 120. A portion of each of light pulses 101 are passed by beam splitter 120 to sample 130. Sample 130 may be a solid sample held in a holder, or a liquid sample in a cell, or a vapor sample in free space (in the air), or a vapor sample within a cell. As described previously, when light pulses 101 of the pulse train shown in FIG. 1A pass through sample 130, sample molecules within sample 130 alter the condition of cancellation in the time interval between two adjacent light pulses 101. As a result, the pulse train emerging from sample 130 as shown in FIG. 1B includes attenuated light pulses 103, and characteristic light 105 of relatively small intensity located between attenuated light pulses 103. Characteristic light 105 is of interest as characteristic of the sample molecules, and may hereinafter be referred to as characteristic light 105. Also, the pulse train emerging from sample 130 may hereinafter also be referred to as sample light.

The sample light including attenuated light pulses 103 and characteristic light 105 as shown in FIG. 1B is provided from sample 130 to intensity modulator (amplitude modulator) 140, which may be a Mach Zehnder interferometer based intensity modulator, or any other suitable type of optical modulator such as a polarization effect based intensity modulator or an electro-absorption intensity modulator. Intensity modulator 140 is turned on/off by control signal 107. In particular, intensity modulator 140 receives the sample light as shown in FIG. 1B, and at corresponding timing is turned on by control signal 107, to pass characteristic light 105 located between adjacent attenuated light pulses 103 for output to scanning interferometer 150 for detection. On the other hand, intensity modulator 140 is turned off by control signal 107 at corresponding timing coinciding with the times each of the attenuated light pulses 103 of the sample light are incident to intensity modulator 140. That is, intensity modulator 140 is turned off so that attenuated light pulses 103 are not output to scanning interferometer 150. In this manner, attenuated light pulses 103 are substantially removed from the output of intensity modulator 140, so that only characteristic light 105 is output to scanning interferometer 150 for detection. A detected signal 109 having increased signal to noise ratio may thus be output from scanning interferometer 150 responsive to characteristic light 105. That is, since attenuated light pulses 103 of relatively large optical power are not output to scanning interferometer 150, the signal to noise ratio of detected signal 109 output from scanning interferometer 150 may be significantly improved as compared to conventional optical spectrometers.

It should be understood that due to imperfect components and/or imperfect fabrication processes, intensity modulator 140 in practice may not be a perfect optical modulator that can be completely or perfectly turned off to prevent all of each attenuated light pulse 103 from passing therethrough to scanning interferometer 150. However, attenuated light pulses 103 are substantially removed from the sample light by intensity modulator 140, and only an insignificant portion of each attenuated light pulse 103 if any is output to scanning interferometer 150.

Generation of control signal 107 will now be described with further reference to FIG. 2. Beam splitter 120 splits a small portion of each of light pulses 101 of the pulse train generated by pulsed light source 110, and reflects the small portions to mirror 160 as first light pulses. Mirror 160 reflects the first light pulses to adjustable delay 170, which may be any suitable adjustable optical delay device such as a corner cube, a right angle (90 degree) prism, an optical fiber stretcher, or a number of mirrors. As shown, adjustable delay 170 is adjustable in either direction along arrow 104, so that the distance between beam splitter 120 and photodetector (second detector) 180 may be increased or decreased.

Responsive to receipt of the first light pulses from adjustable delay 170, photodetector 180 outputs respective electrical pulses to amplifier 190. Amplifier 190 amplifies the electrical pulses and outputs the amplified electrical pulses to intensity modulator 140 as control signal 107, which includes a train of electrical control pulses corresponding to the first light pulses incident to photodetector 180. The control pulses of control signal 107 turn intensity modulator 140 off in synchronization with the timing at which attenuated light pulses 103 are incident to intensity modulator 140. Accordingly, responsive to a control pulse of control signal 107, intensity modulator 140 is turned off so that attenuated light pulses 103 are not output to scanning interferometer 150. Responsive to absence of a control pulse of control signal 107, intensity modulator 140 remains on to pass characteristic light 105 to scanning interferometer 150.

In more detail, a corresponding electrical pulse is generated by photodetector 180 responsive to a particular light pulse 101 of the pulse train generated by pulsed light source 110. Adjustable delay 170 may be adjusted in either direction along arrow 104 during set up of optical spectrometer 10, to increase or decrease the amount of delay between occurrence of the particular light pulse 101 and generation of the corresponding electrical pulse by photodetector 180, so that the control pulses of control signal 107 as provided from amplifier 190 may coincide with the timing at which attenuated light pulses 103 are incident to intensity modulator 140.

In a representative embodiment, the delay as provided by adjustable delay 170 may be selected so that when an attenuated light pulse 103 corresponding to a particular light pulse 101 generated by pulsed light source 110 is incident to intensity modulator 140, the control pulse of control signal 107 that turns intensity modulator 140 off is generated responsive to the same particular light pulse 101. The following control pulses of control signal 107 may be generated similarly. The arrangement according to this representative embodiment reduces the unwanted effects caused by the time jitter from one pulse to the next.

In a further representative embodiment, the delay as provided by adjustable delay 170 may be selected to be greater than mentioned above, so that when an attenuated light pulse 103 corresponding to a particular light pulse 101 generated by pulsed light source 110 is incident to intensity modulator 140, the control pulse of control signal 107 that turns intensity modulator 140 off is generated responsive to a light pulse 101 that is generated by pulsed light source 110 prior to the particular light pulse 101. That is, the control pulse may be generated responsive to a light pulse 101 generated immediately prior to the particular light pulse 101, or generated responsive to another earlier generated light pulse 101. The following control pulses of control signal 107 may be generated similarly.

In a still further representative embodiment, the delay as provided by adjustable delay 170 may be selected during set up of optical spectrometer 10, so that when an attenuated light pulse 103 corresponding to a particular light pulse 101 generated by pulsed light source 110 is incident to intensity modulator 140, the control pulse of control signal 107 that turns intensity modulator 140 off is generated responsive to a light pulse 101 that is generated by pulsed light source 110 after the particular light pulse 101. That is, the control pulse may be generated responsive to a light pulse 101 generated immediately after the particular light pulse 101, or generated responsive to another later generated light pulse 101. The following control pulses of control signal 107 may be generated similarly.

FIG. 3 is a block diagram illustrating an optical spectrometer 20, according to a representative embodiment. Optical spectrometer 20 may include similar features as optical spectrometer 10 shown in FIG. 2, including somewhat similar references numerals. Detailed description of such similar features may be omitted from the following.

Pulsed light source 210 in FIG. 3 generates a pulse train such as shown in FIG. 1A, that includes light pulses 101 as described previously. Light pulses 101 of the pulse train generated by pulsed light source 210 are output to beam splitter 220. A portion of each of light pulses 101 are passed by beam splitter 220 to adjustable delay 235, which may be any suitable adjustable optical delay device such as a corner cube, or a right angle (90 degree) prism, or an optical fiber stretcher, or a number of mirrors, for example. The delayed light pulses of the pulse train are output from adjustable delay 235 to sample 230. Sample 230 may be a solid sample held in a holder, or a liquid sample in a cell, or a vapor sample in free space (in the air), or a vapor sample within a cell. When the delayed light pulses of the pulse train output from adjustable delay 235 pass through sample 230, the pulse train emerging from sample 230 includes attenuated light pulses 103 that correspond to the delayed light pulses of the incident pulse train, and characteristic light 105 of relatively small intensity located between attenuated light pulses 103, such as shown in FIG. 1B. The sample light including attenuated light pulses 103 and characteristic light 105 as shown in FIG. 1B is provided from sample 230 to intensity modulator 240, which is turned on/off by control signal 207. Intensity modulator 240 receives the sample light as shown in FIG. 1B, and at corresponding timing is turned on by control signal 207, to pass characteristic light 105 located between adjacent attenuated light pulses 103 for output to scanning interferometer 250 for detection. On the other hand, intensity modulator 240 is turned off by control signal 207 at corresponding timing coinciding with the times each of the attenuated light pulses 103 of the sample light are incident to intensity modulator 240. In this manner, attenuated light pulses 103 are substantially removed from the output of intensity modulator 240, so that only characteristic light 105 is output to scanning interferometer 250 for detection. A detected signal 209 having increased signal to noise ratio may thus be output from scanning interferometer 250 responsive to characteristic light 105.

As further shown in FIG. 3, beam splitter 220 splits a small portion of each of light pulses 101 of the pulse train generated by pulsed light source 210, and reflects the small portions as first light pulses to photodetector 280, which generates and outputs respective electrical pulses to amplifier 290 responsive to the first light pulses incident thereto. Amplifier 290 amplifies the electrical pulses and outputs the amplified electrical pulses to intensity modulator 240 as control signal 207, which includes a train of electrical control pulses corresponding to the first light pulses incident to photodetector 280, to control the on/off state of intensity modulator 240.

In a representative embodiment, the delay as provided by adjustable delay 235 may be selected so that when an attenuated light pulse 103 corresponding to a particular light pulse 101 generated by pulsed light source 210 is incident to intensity modulator 240, the control pulse of control signal 207 that turns intensity modulator 240 off is generated responsive to the same particular light pulse 101. The following control pulses of control signal 207 may be generated similarly. The arrangement according to this representative embodiment reduces the unwanted effects caused by the time jitter from one pulse to the next. This optical spectrometer increases the signal-to-noise ratio of the detected signal, has an improved dynamic range, and potentially offers a zero-background detection method.

In a further representative embodiment, the delay as provided by adjustable delay 235 may be selected to be smaller than mentioned above, so that when an attenuated light pulse 103 corresponding to a particular light pulse 101 generated by pulsed light source 210 is incident to intensity modulator 240, the control pulse of control signal 207 that turns intensity modulator 240 off is generated responsive to a light pulse 101 that is generated by pulsed light source 210 prior to the particular light pulse 101. That is, the control pulse may be generated responsive to a light pulse 101 generated immediately prior to the particular light pulse 101, or generated responsive to another earlier generated light pulse 101. The following control pulses of control signal 207 may be generated similarly.

In a still further representative embodiment, the delay as provided by adjustable delay 235 may be selected during set up of optical spectrometer 20, so that when an attenuated light pulse 103 corresponding to a particular light pulse 101 generated by pulsed light source 210 is incident to intensity modulator 240, the control pulse of control signal 207 that turns intensity modulator 240 off is generated responsive to a light pulse 101 that is generated by pulsed light source 210 after the particular light pulse 101. That is, the control pulse may be generated responsive to a light pulse 101 generated immediately after the particular light pulse 101, or generated responsive to another later generated light pulse 101. The following control pulses of control signal 207 may be generated similarly.

In a variation of optical spectrometer 20 as described with respect to FIG. 3, a mirror and an adjustable delay such as mirror 160 and adjustable delay 170 shown in FIG. 2 may be inserted between beam splitter 220 and photodetector 280 to enable adjustable delay of the first light pulses provided to photodetector 280. In a still further variation of optical spectrometer 20 as described with respect to FIG. 3, adjustable delay 235 may be disposed between sample 230 and intensity modulator 240, instead of before sample 230.

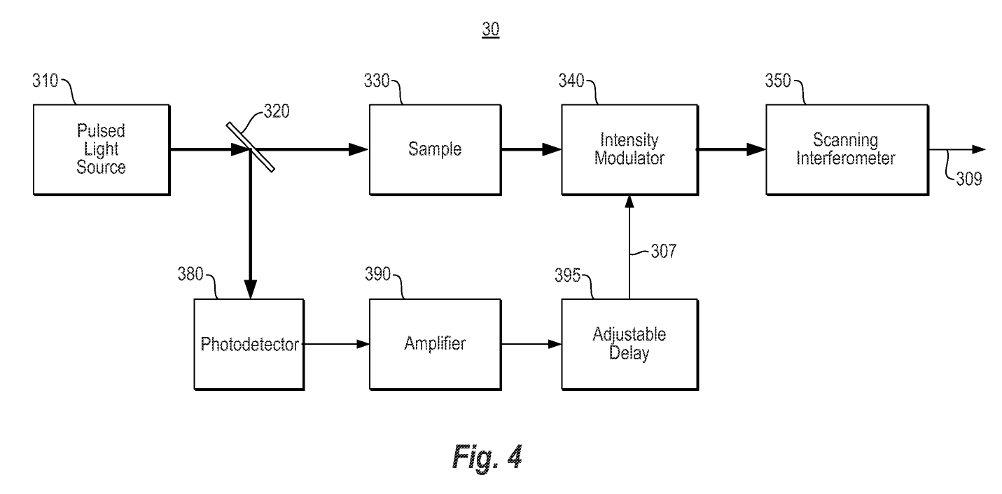

FIG. 4 is a block diagram illustrating an optical spectrometer 30, according to a representative embodiment. Optical spectrometer 30 may include similar features as optical spectrometer 10 shown in FIG. 2, including somewhat similar reference numerals. Detailed description of such similar features may be omitted from the following.

Pulsed light source 310 in FIG. 4 generates a pulse train such as shown in FIG. 1A, that includes light pulses 101 as described previously. Light pulses 101 of the pulse train generated by pulsed light source 310 are output to beam splitter 320. A portion of each of light pulses 101 is passed by beam splitter 320 to sample 330. Sample 330 may be a solid sample held in a holder, or a liquid sample in a cell, or a vapor sample in free space (in the air), or a vapor sample within a cell. When the light pulses 101 of the pulse train from beam splitter 320 pass through sample 330, the pulse train emerging from sample 330 includes attenuated light pulses 103 that correspond to the light pulses 101 of the incident pulse train, and characteristic light 105 of relatively small intensity located between attenuated light pulses 103, such as shown in FIG. 1B. The sample light including attenuated light pulses 103 and characteristic light 105 as shown in FIG. 1B is provided from sample 330 to intensity modulator 340, which is turned on/off by control signal 307. Intensity modulator 340 receives the sample light as shown in FIG. 1B, and at corresponding timing is turned on by control signal 307, to pass characteristic light 105 located between adjacent attenuated light pulses 103 for output to scanning interferometer 350 for detection. On the other hand, intensity modulator 340 is turned off by control signal 307 at corresponding timing coinciding with the times each of the attenuated light pulses 103 of the sample light are incident to intensity modulator 340. In this manner, attenuated light pulses 103 are substantially removed from the output of intensity modulator 340, so that only characteristic light 105 is output to scanning interferometer 350 for detection. A detected signal 309 having increased signal to noise ratio may thus be output from scanning interferometer 350 responsive to characteristic light 105.

As further shown in FIG. 4, beam splitter 320 splits a small portion of each of light pulses 101 of the pulse train generated by pulsed light source 310, and reflects the small portions as first light pulses to photodetector 380, which generates and outputs respective electrical pulses to amplifier 390 responsive to the first light pulses incident thereto. Amplifier 390 amplifies the electrical pulses and outputs the amplified electrical pulses as a control signal, which includes a train of electrical control pulses corresponding to the first light pulses incident to photodetector 380. The control signal from amplifier 390 is output to adjustable delay 395, which delays the control signal to provide a delayed control signal that is output to intensity modulator 340 as control signal 307. Adjustable delay 395 may be any suitable electrical delay device such as a stretchable coaxial cable, or a trombone delay line, or a slow wave structure delay line. The delay as provided by adjustable delay 395 may be selected during set up of optical spectrometer 30, so that when an attenuated light pulse 103 corresponding to a particular light pulse 101 generated by pulsed light source 310 is incident to intensity modulator 340, the control pulse of control signal 307 that turns intensity modulator 340 off is generated responsive to the same particular light pulse 101. The following control pulses of control signal 307 may be generated similarly. The arrangement of this representative embodiment reduces the unwanted effects caused by the time jitter from one pulse to the next. As a variation, adjustable delay 395 could be placed between photodetector 380 and amplifier 390.

In a further representative embodiment, the delay as provided by adjustable delay 395 may be selected to be greater than mentioned above, so that when an attenuated light pulse 103 corresponding to a particular light pulse 101 generated by pulsed light source 310 is incident to intensity modulator 340, the control pulse of control signal 307 that turns intensity modulator 340 off is generated responsive to a light pulse 101 that is generated by pulsed light source 310 prior to the particular light pulse 101. That is, the control pulse may be generated responsive to a light pulse 101 generated immediately prior to the particular light pulse 101, or generated responsive to another earlier generated light pulse 101. The following control pulses of control signal 307 may be generated similarly.

In a still further representative embodiment, the delay as provided by adjustable delay 395 may be selected during set up of optical spectrometer 30, so that when an attenuated light pulse 103 corresponding to a particular light pulse 101 generated by pulsed light source 310 is incident to intensity modulator 340, the control pulse of control signal 307 that turns intensity modulator 340 off is generated responsive to a light pulse 101 that is generated by pulsed light source 310 after the particular light pulse 101. That is, the control pulse may be generated responsive to a light pulse 101 generated immediately after the particular light pulse 101, or generated responsive to another later generated light pulse 101. The following control pulses of control signal 307 may be generated similarly.

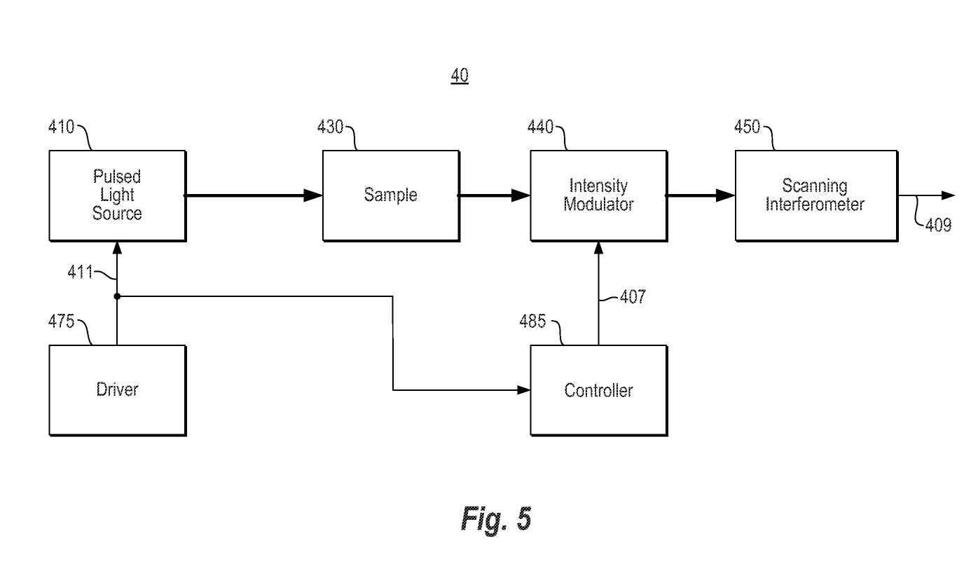

FIG. 5 is a block diagram illustrating an optical spectrometer 40, according to a representative embodiment. Optical spectrometer 40 may include similar features as optical spectrometer 10 shown in FIG. 2, including somewhat similar reference numerals. Detailed description of such similar features may be omitted from the following.

Pulsed light source 410 in FIG. 5 generates a pulse train that includes light pulses 101 such as shown in FIG. 1A, responsive to electrical drive signal 411 generated by driver 475. Driver 475 may be a stable oscillator such as a quartz crystal oscillator or a surface acoustic wave oscillator. Light pulses 101 of the pulse train generated by pulsed light source 410 are output to sample 430. Sample 430 may be a solid sample held in a holder, or a liquid sample in a cell, or a vapor sample in free space (in the air), or a vapor sample within a cell. When light pulses 101 of the pulse train from pulsed light source 410 pass through sample 430, the pulse train emerging from sample 430 includes attenuated light pulses 103 that correspond to light pulses 101 of the incident pulse train, and characteristic light 105 of relatively small intensity located between attenuated light pulses 103, such as shown in FIG. 1B. The sample light including attenuated light pulses 103 and characteristic light 105 as shown in FIG. 1B is provided from sample 430 to intensity modulator 440, which is turned on/off by control signal 407. Intensity modulator 440 receives the sample light as shown in FIG. 1B, and at corresponding timing is turned on by control signal 407, to pass characteristic light 105 located between adjacent attenuated light pulses 103 for output to scanning interferometer 450 for detection. On the other hand, intensity modulator 440 is turned off by control signal 407 at corresponding timing coinciding with the times each of the attenuated light pulses 103 of the sample light are incident to intensity modulator 440. In this manner, attenuated light pulses 103 are substantially removed from the output of intensity modulator 440, so that only characteristic light 105 is output to scanning interferometer 450 for detection. A detected signal 409 having increased signal to noise ratio may thus be output from scanning interferometer 450 responsive to characteristic light 105.

As further shown in FIG. 5, electrical drive signal 411 generated by driver 475 is also output to controller 485, which generates control signal 407 responsive to electrical drive signal 411. Controller 485 generates control signal 407 as including a train of electrical control pulses having corresponding timing, so that when an attenuated light pulse 103 corresponding to a particular light pulse 101 generated responsive to a particular portion (i.e., pulse) of electrical drive signal 411 is incident to intensity modulator 440, the control pulse of control signal 407 that turns intensity modulator 440 off is generated responsive to the same particular portion of electrical drive signal 411. That is, electrical drive signal 411 (i.e., a train of pulses) determines the timing of generation of light pulses 101 by pulsed light source 410. The timing of the control pulses which turn off intensity modulator 440 is also determined responsive to electrical drive signal 411, directly without detecting light pulses 101. In a variation, electrical drive signal 411 may be a sine wave. Light pulses 101 may be generated by pulsed light source 410 responsive to peaks (or valleys) of the sine wave. In this variation, the control pulse of control signal 407 that turns intensity modulator 440 off is generated responsive to the same particular portion of electrical drive signal 411, i.e., the same peak (or valley) of the sine wave. Other waveforms might also be used as the electrical drive signal 411. The following control pulses of control signal 407 may be generated similarly. The arrangement of this representative embodiment reduces the unwanted effects caused by the time jitter from one pulse to the next.

Controller 485 as shown in FIG. 5 may be constructed of any combination of hardware (electronic and/or optical, e.g., phase locked loop and/or optical phase locked loop), firmware or software architectures, and may include its own memory (e.g., nonvolatile memory) for storing executable software/firmware executable code that allows it to perform various process operations including generation of control signal 407. Alternatively, the executable code may be stored in designated memory locations within a separate memory. The memory may be any number, type and combination of external and internal nonvolatile read only memory (ROM) and volatile random access memory (RAM), and may store various types of information, such as signals and/or computer programs and software algorithms executable by controller 485. The memory may include any number, type and combination of tangible computer readable storage media, such as a disk drive, an electrically programmable read-only memory (EPROM), an electrically erasable and programmable read only memory (EEPROM), a CD, a DVD, a universal serial bus (USB) drive, and the like.

In a further representative embodiment, controller 485 may generate control signal 407, so that when an attenuated light pulse 103 corresponding to a particular light pulse 101 generated responsive to a particular portion (i.e., pulse, peak or valley) of electrical drive signal 411 is incident to intensity modulator 440, the control pulse of control signal 407 that turns intensity modulator 440 off is generated responsive to a corresponding portion of electrical drive signal 411 prior to the particular portion. The following control pulses of control signal 407 may be generated similarly.

In a still further representative embodiment, controller 485 may generate control signal 407, so that when an attenuated light pulse 103 corresponding to a particular light pulse 101 generated responsive to a particular portion (i.e., pulse, peak or valley) of electrical drive signal 411 is incident to intensity modulator 440, the control pulse of control signal 407 that turns intensity modulator 440 off is generated responsive to a corresponding portion of electrical drive signal 411 after the particular portion. The following control pulses of control signal 407 may be generated similarly.

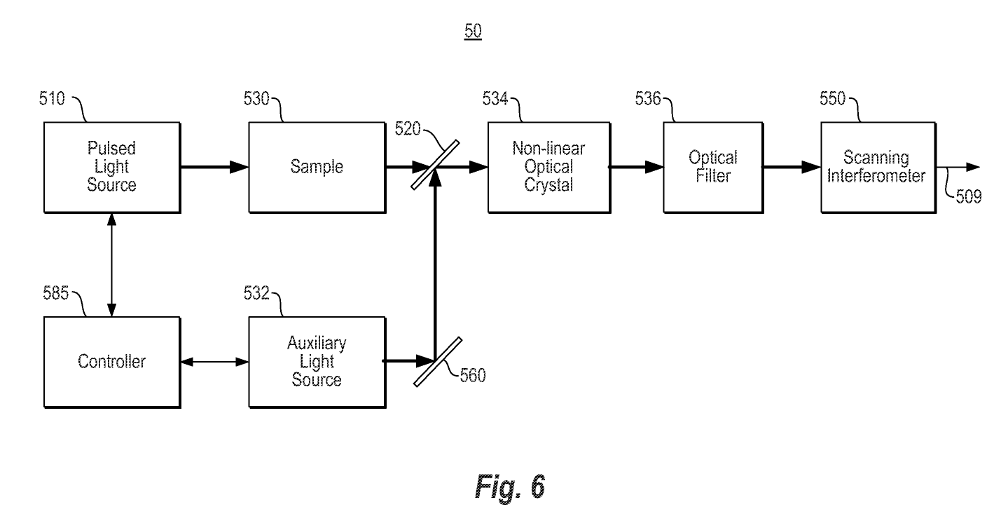

FIG. 6 is a block diagram illustrating an optical spectrometer 50, according to a representative embodiment. Pulsed light source 510 in FIG. 6 generates a pulse train such as shown in FIG. 1A, that includes light pulses 101 as described previously. Light pulses 101 of the pulse train generated by pulsed light source 510 are output to sample 530. Sample 530 may be a solid sample held in a holder, or a liquid sample in a cell, or a vapor sample in free space (in the air), or a vapor sample within a cell. When the light pulses 101 of the pulse train output from pulsed light source 510 pass through sample 530, the pulse train emerging from sample 530 includes attenuated light pulses 103 that correspond to the light pulses 101 of the incident pulse train, and characteristic light 105 of relatively small intensity located between attenuated light pulses 103, such as shown in FIG. 1B. The sample light including attenuated light pulses 103 and characteristic light 105 as shown in FIG. 1B is provided from sample 530 through beam splitter 520 to non-linear optical crystal 534. Beam splitter 520 may alternatively be a dichroic mirror, or a polarizing beam splitter (polarization beam splitter), or a grating, or a prism.

As further shown in FIG. 6, auxiliary light source 532 generates auxiliary light that is output to mirror 560. The auxiliary light is reflected by mirror 560 to beam splitter 520, and is then further reflected by beam splitter 520 to non-linear optical crystal 534. Accordingly, both the sample light including attenuated light pulses 103 and characteristic light 105, and the auxiliary light are provided as incident to non-linear optical crystal 534. Controller 585 as connected to pulsed light source 510 and auxiliary light source 532 controls the timing of the pulse train generated and output from pulsed light source 510, and the auxiliary light generated and output from auxiliary light source 532, as will be subsequently described. Although shown in FIG. 6 as interconnected by electrical signals, controller 585 may receive and send both optical signals and electric signals to pulsed light source 510 and auxiliary light source 532. Controller 585 may be constructed using optical processes (linear and non-linear) and/or electrical processes. Furthermore, controller 585 may be constructed of any combination of hardware, firmware or software architectures, and also may include its own memory and/or separate memory, in a similar manner as controller 485 described with reference to FIG. 5.

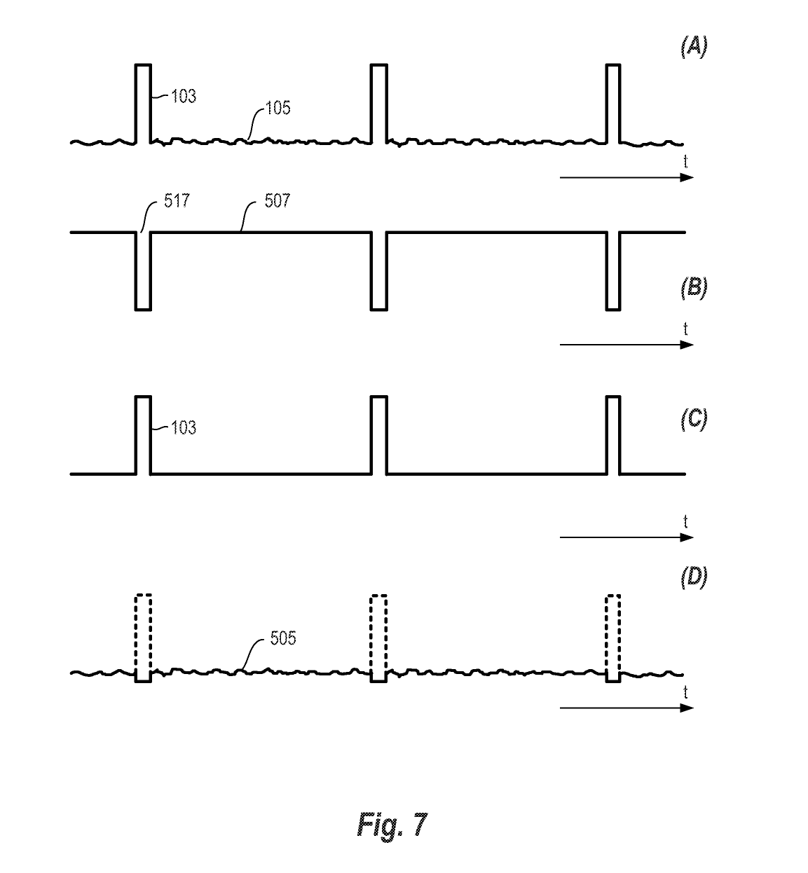

Operation of optical spectrometer 50 shown in FIG. 6 will now be described with reference to FIGS. 7A-7D. FIG. 7A is a diagram illustrating a pulse train after passing through sample 530, including attenuated light pulses 103 and characteristic light 105 that are both in a same second frequency band F2. FIG. 7B is a diagram illustrating auxiliary light generated by auxiliary light source 532, the auxiliary light in a third frequency band F3 different than the second frequency band F2 or the same as the second frequency band F2. FIG. 7C is a diagram illustrating attenuated light pulses 103 output from non-linear optical crystal 534, the attenuated light pulses 103 having passed through non-linear optical crystal 534 without mixing to still be in the second frequency band F2. FIG. 7D is a diagram illustrating converted characteristic light 505 which has been mixed with the auxiliary light by non-linear optical crystal 534 to be in a first frequency band F1 different than the second and third frequency bands F2 and F3. It is to be understood that as noted above and in the following description, F1, F2 and F3 are indicative of frequency bands, in contrast to individual respective single frequencies.

In greater detail, in this representative embodiment, the auxiliary light generated by auxiliary light source 532 has transmission regions 507 including light in the third frequency band F3, and dark regions 517 where no light is generated, as shown in FIG. 7B. Controller 585 controls timing of generation of the pulse train output from pulsed light source 510 and generation of the auxiliary light output from auxiliary light source 532. The sample light from sample 530 as shown in FIG. 7A and the auxiliary light as shown in FIG. 7B are thus incident to non-linear optical crystal 534 synchronized in time with each other, so that dark regions 517 are aligned in time with attenuated light pulses 103, and so that transmission regions 507 are aligned in time with characteristic light 105. As an alternative, an adjustable optical delay may be disposed between pulsed light source 510 and beam splitter 520, and/or between auxiliary light source 532 and beam splitter 520, to provide alignment.

Non-linear optical crystal 534 non-linearly converts the sample light as provided from sample 530 responsive to the auxiliary light output from auxiliary light source 532. Characteristic light 105 in the second frequency band F2 is mixed with the auxiliary light in the third frequency band F3, and is thus converted into light in the first frequency band F1, which is shown in FIG. 7D as converted characteristic light 505. The first frequency band F1 may be defined as F1=F2+F3, or F1=F2−F3, or F1=F3−F2. In absence of auxiliary light incident to non-linear optical crystal 534 (dark regions 517), attenuated light pulses 103 are passed by non-linear optical crystal 534 without mixing and are thus output as maintained in the second frequency band F2, as shown in FIG. 7C. Incidentally, in FIG. 7D the dotted lines are indicative of attenuated light pulses 103 that are not converted to be in first frequency band F1.

Accordingly, responsive to the sample light and auxiliary light synchronized in time with each other, non-linear optical crystal 534 outputs converted characteristic light 505 in the first frequency band F1, attenuated light pulses 103 in the second frequency band F2, and undepleted auxiliary light in the third frequency band to optical filter 536. Ideally, the auxiliary light will convert all of the photons in the characteristic light 105 from the second frequency band F2 to the first frequency band F1. However, in some cases when all photons in the characteristic light 105 have been converted, the conversion process will stop and left over auxiliary light if any may propagate from non-linear optical crystal 534 as undepleted auxiliary light. Optical filter 536 is configured to select light of the first frequency band F1 and to block other light including light in the second and third frequency bands F2 and F3. Consequently, optical filter 536 selects and outputs converted characteristic light 505 to scanning interferometer 550 for detection. A detected signal 509 having increased signal to noise ratio may thus be output from scanning interferometer 550 responsive to converted characteristic light 505. Incidentally, a grating or a prism, or a polarizing beam splitter (polarization beam splitter) may be used instead of optical filter 536 to select converted characteristic light 505. In an alternative embodiment, scanning interferometer 550 may be configured to include a photodetector that has no response to frequency bands F2 and F3. That is, the wavelength (optical frequency) response window of this photodetector serves as an optical filter that may replace optical filter 536.

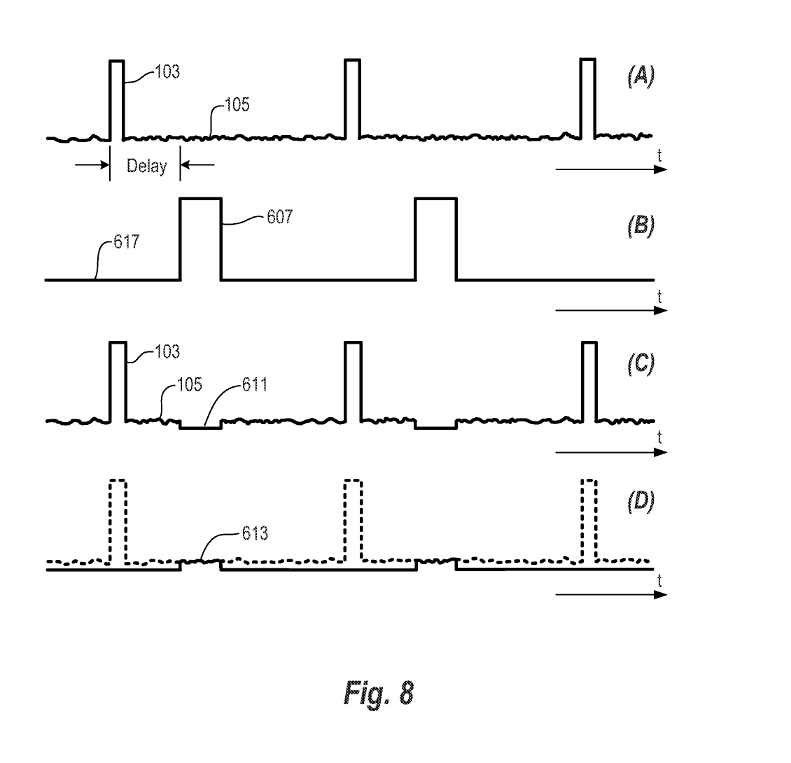

In the representative embodiment as described with reference to FIG. 6 and FIGS. 7A-7D, transmission regions 507 of the auxiliary light are aligned in time with the entirety of characteristic light 105 between each respective pair of adjacent attenuated light pulses 103. The representative embodiment of FIGS. 7A-7D thus corresponds to a full sampling mode, whereby the entirety of the characteristic light 105 between each respective pair of attenuated light pulses 103 is provided to scanning interferometer 550 for detection via optical filter 536 shown in FIG. 6. Operation of optical spectrometer 50 shown in FIG. 6 in a partial sampling mode in accordance with a further representative embodiment will now be described with reference to FIGS. 8A-8D.

FIG. 8A is a diagram illustrating a pulse train after passing through sample 530, including attenuated light pulses 103 and characteristic light 105 that are both in a same second frequency band F2. FIG. 8B is a diagram illustrating auxiliary light generated by auxiliary light source 532, the auxiliary light in a third frequency band F3 different than the second frequency band F2 or the same as the second frequency band F2. FIG. 8C is a diagram illustrating attenuated light pulses 103 and portions of characteristic light 105 output from non-linear optical crystal 534, the attenuated light pulses 103 and the portions of characteristic light 105 having passed through non-linear optical crystal 534 without mixing to still be in the second frequency band F2. FIG. 8D is a diagram illustrating portions of converted characteristic light 613 which have been mixed with the auxiliary light by non-linear optical crystal 534 to be in a first frequency band F1 different than the second and third frequency bands F2 and F3.

In greater detail, in this representative embodiment described with reference to FIGS. 8A-8D, the auxiliary light generated by auxiliary light source 532 has transmission regions 607 including light in the third frequency band F3, and dark regions 617 where no light is generated, as shown in FIG. 8B. Controller 585 controls timing of generation of the pulse train output from pulsed light source 510 and generation of the auxiliary light output from auxiliary light source 532. The sample light from sample 530 as shown in FIG. 8A and the auxiliary light as shown in FIG. 8B are thus incident to non-linear optical crystal 534 synchronized in time with each other, so that transmission regions 607 each having a same corresponding duration are respectively incident to non-linear optical crystal 534 a same preselected delay time after a respective attenuated light pulse 103. Transmission regions 607 of the auxiliary light are thus respectively located and aligned with a corresponding same portion of characteristic light 105 between respective different pairs of attenuated light pulses 103. As an alternative, an adjustable optical delay may be disposed between pulsed light source 510 and beam splitter 520, and/or between auxiliary light source 532 and beam splitter 520, to provide alignment.

Non-linear optical crystal 534 non-linearly converts the sample light as provided from sample 530 responsive to the auxiliary light output from auxiliary light source 532. Portions of characteristic light 105 in the second frequency band F2 are respectively mixed with the auxiliary light in the third frequency band F3, and are thus converted into light in the first frequency band F1 which is shown in FIG. 8D as converted characteristic light 613. The first frequency band F1 may be defined as F1=F2+F3, or F1=F2−F3, or F1=F3−F2. In absence of auxiliary light incident to non-linear optical crystal 534 (dark regions 617), attenuated light pulses 103 and portions of characteristic light 105 are passed by non-linear optical crystal 534 without mixing and are thus output as maintained in the second frequency band F2, as shown in FIG. 8C. In FIG. 8D the dotted lines are indicative of the attenuated light pulses 103 and the portions of characteristic light 105 that are not converted to be in first frequency band F1. Also, in FIG. 8C, the portions of characteristic light 105 that have been mixed and converted to first frequency band F1 and which thus are not maintained as in frequency band F2, are indicated at 611.

Accordingly, responsive to the sample light and auxiliary light incident thereto synchronized in time with each other, non-linear optical crystal 534 outputs portions of converted characteristic light 613 in the first frequency band F1, attenuated light pulses 103 and portions of characteristic light 105 in the second frequency band F2, and undepleted auxiliary light in the third frequency band F3 to optical filter 536. Optical filter 536 is configured to select light of the first frequency band F1 and to block other light including light in the second and third frequency bands F2 and F3. Consequently, optical filter 536 selects and outputs portions of converted characteristic light 613 to scanning interferometer 550 for detection. A detected signal 509 having increased signal to noise ratio may thus be output from scanning interferometer 550 responsive to converted characteristic light 613. In the partial sampling of this representative embodiment, selected portions of the characteristic light 105 between respective pairs of attenuated light pulses 103 are sampled, in contrast to the representative embodiment as described with reference to FIGS. 7A-7D where the entirety of the characteristic light 105 between respective pairs of attenuated light pulses 103 are sampled.

The auxiliary light and the sample light may be incident to non-linear optical crystal 534 synchronized in time with each other so that in the representative embodiment as described with reference to FIGS. 8A-8D, transmission regions 607 of the auxiliary light may be respectively located and aligned with a same corresponding portion of characteristic light 105 between respective pairs of attenuated light pulses 103. That is, transmission regions 607 of the auxiliary light may be synchronized so that the same selected portions of characteristic light 105 are successively output to scanning interferometer 550 for sampling. However, in a representative embodiment controller 585 may change the synchronization between pulsed light source 510 and auxiliary light source 532, so that after a certain period of time, transmission regions 607 can be aligned to a different portion of characteristic light 105. That is, after the certain period of time, transmission regions 607 of the auxiliary light may subsequently be respectively located and aligned with a different portion of characteristic light 105 between the respective pairs of attenuated light pulses 103 than previously, so that a different portion of characteristic light 105 may be successively output to scanning interferometer 550. In this alternative, a sampling window of the characteristic light 105 may be moved, so that eventually the entirety of the characteristic light 105 may be output to scanning interferometer 550 for sampling. As an alternative, an adjustable optical delay may be disposed between pulsed light source 510 and beam splitter 520, and/or between auxiliary light source 532 and beam splitter 520, to provide alignment.

In the embodiments described with respect to FIGS. 7 and 8, a characteristic of auxiliary light source 532 is that there is essentially no light in the dark regions 517 or 617. Auxiliary light source 532 of FIG. 6 may be a dark pulse laser, or a dark solution laser. Alternatively, auxiliary light source 532 may consist of a continuous wave (cw) light source (e.g., a cw laser), a pulsed light source synchronized to pulsed light source 510, and a non-linear optical device. The non-linear optical conversion (e.g., sum frequency generation) performed by the non-linear optical device, depletes the photons in the cw light to generate dark regions 517 or 617. The resultant cw light with dark regions 517 or 617 serves as the auxiliary light such as shown in FIG. 7(B) and FIG. 8(B). Corresponding optical and/or electrical pulse width control (pulse broadening and/or pulse narrowing) and pulse synchronization may be used in forming the auxiliary light.

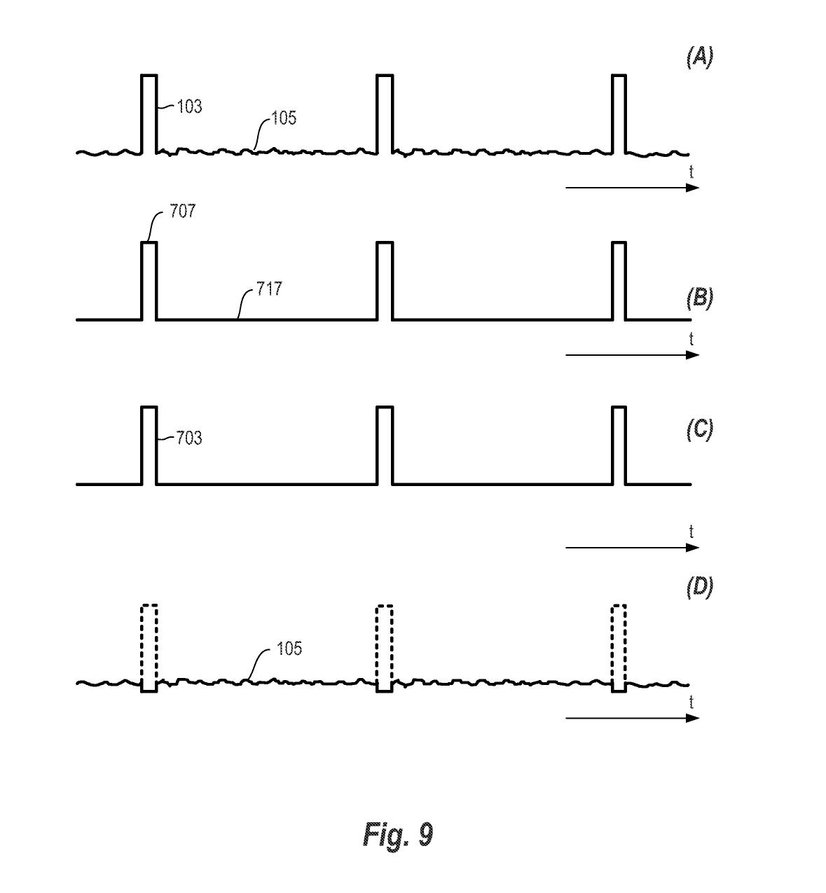

Operation of optical spectrometer 50 shown in FIG. 6 in accordance with a still further representative embodiment will now be described with reference to FIGS. 9A-9D. FIG. 9A is a diagram illustrating a pulse train after passing through sample 530 of FIG. 6, including attenuated light pulses 103 and characteristic light 105 that are both in a same first frequency band F1. FIG. 9B is a diagram illustrating auxiliary light generated by auxiliary light source 532, the auxiliary light in a third frequency band F3 different than the first frequency band F1 or the same as the first frequency band F1. FIG. 9C is a diagram illustrating converted attenuated light pulses 703 which are the attenuated light pulses 103 mixed with the auxiliary light by non-linear optical crystal 534 to be in a second frequency band F2 different than the first frequency band F1. FIG. 9D is a diagram illustrating characteristic light 105 output from non-linear optical crystal 534, characteristic light 105 having passed through non-linear optical crystal 534 without mixing to still be in the first frequency band F1.

In this representative embodiment described with reference to FIGS. 9A-9D, the auxiliary light generated by auxiliary light source 532 has transmission regions 707 including light in the third frequency band F3, and dark regions 717 where no light is generated, as shown in FIG. 9B. Controller 585 shown in FIG. 6 controls timing of generation of the pulse train output from pulsed light source 510 and generation of the auxiliary light output from auxiliary light source 532. The sample light from sample 530 as shown in FIG. 9A and the auxiliary light as shown in FIG. 9B are thus incident to non-linear optical crystal 534 synchronized in time with each other, so that dark regions 717 are aligned in time with characteristic light 105, and transmission regions 707 are aligned in time with attenuated light pulses 103.

Non-linear optical crystal 534 non-linearly converts the sample light as provided from sample 530 responsive to the auxiliary light output from auxiliary light source 532. Attenuated light pulses 103 in the first frequency band F1 are mixed with the auxiliary light in the third frequency band F3, and are thus converted into light in the second frequency band F2 which is shown in FIG. 9C as converted attenuated light pulses 703. The second frequency band F2 may be defined as F2=F1+F3, or F2=F1−F3, or F2=F3−F1. In absence of auxiliary light incident to non-linear optical crystal 534 (dark regions 717), characteristic light 105 is passed by non-linear optical crystal 534 without mixing and is thus output as maintained in the first frequency band F1, as shown in FIG. 9D. In FIG. 9D, the dotted lines are indicative of converted attenuated light pulses 703 that are converted to the second frequency band F2, and thus are no longer in the first frequency band F1.

Accordingly, responsive to the sample light and auxiliary light incident thereto synchronized in time with each other, non-linear optical crystal 534 outputs converted attenuated light pulses 703 in the second frequency band F2, characteristic light 105 in the first frequency band F1, and undepleted auxiliary light in the third frequency band F3 to optical filter 536. Optical filter 536 is configured to select light of the first frequency band F1, and to block other light including light in the second and third frequency bands F2 and F3. Consequently, optical filter 536 selects and outputs characteristic light 105 to scanning interferometer 550 for detection. A detected signal 509 having increased signal to noise ratio may thus be output from scanning interferometer 550 responsive to converted characteristic light 505.

In the embodiments described with respect to FIG. 6, non-linear optical crystal 534 is either a bulk crystal or a non-linear optical crystal based waveguide device that provides a non-linear optical conversion process such as sum frequency generation and difference frequency generation. However, non-linear optical crystal 534 may also have artificial microstructure to enhance the required non-linear conversion. Examples of the non-linear optical crystals with microstructure include periodically poled lithium niobate (PPLN) crystal, periodically poled potassium titanyl phosphate crystal, orientation patterned gallium arsenide (OP-GaAs) crystal, etc., either as a bulk crystal or in combination with a waveguide structure. Other non-linear optical devices such as a nonlinear optical fiber or a photonic crystal optical fiber can also be used to provide the required non-linear optical conversion. In addition, higher order non-linear optical conversion can be used. For example, so-called “four-wave mixing” F1=2×F2−F3 can be used to respectively generate converted characteristic light 505 and 613 in the first frequency band F1 as shown in FIG. 7(D) and FIG. 8(D). It should thus be understood that mixing as described with respect to FIG. 6 may include such higher order non-linear optical conversion processes.

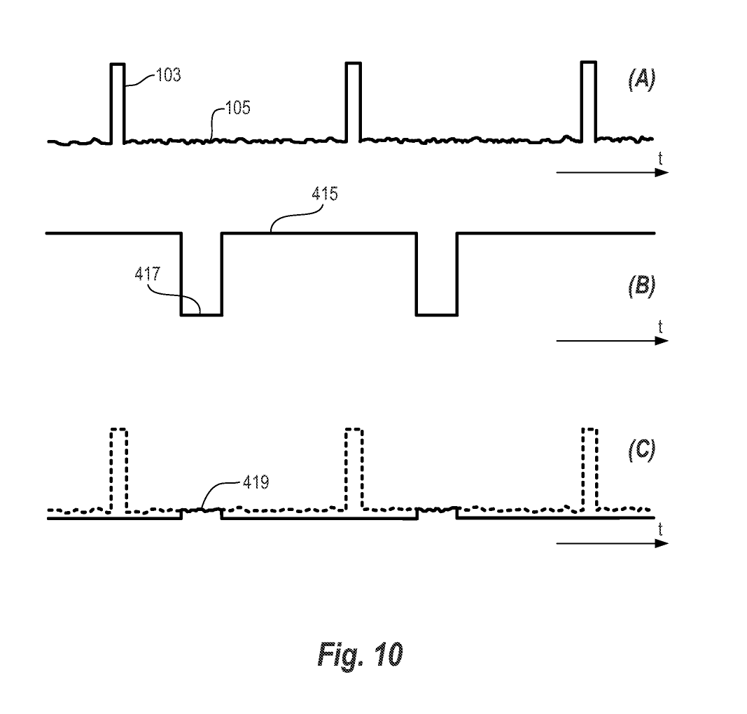

In another representative embodiment, optical spectrometer 40 as shown in FIG. 5 may be operated in a partial sampling mode, which will be described with reference to FIGS. 10A-10C. It is to be understood that in this further representative embodiment, optical spectrometer 40 operates generally as described with respect to FIG. 5, and that detailed description of the operation and features may be omitted from the following.

FIG. 10A is a diagram illustrating a pulse train after passing through sample 430 of FIG. 5, including attenuated light pulses 103 and characteristic light 105 between each respective pair of attenuated light pulses 103. FIG. 10B is a diagram illustrating control signal 407 as provided from controller 485, including electrical control pulses 415. FIG. 10C is a diagram illustrating portions of characteristic light 419 output from intensity modulator 440 to scanning interferometer 450.

Pulsed light source 410 in FIG. 5 generates a pulse train that includes light pulses 101 such as shown in FIG. 1A, responsive to electrical drive signal 411 generated by driver 475. The sample light including attenuated light pulses 103 and characteristic light 105 as shown in FIG. 10A is subsequently provided from sample 430 to intensity modulator 440. Electrical drive signal 411 generated by driver 475 is also output to controller 485, which generates control signal 407 responsive to electrical drive signal 411, to turn intensity modulator 440 on/off. Controller 485 generates control signal 407 as shown in FIG. 10B, which includes a train of electrical control pulses 415 having corresponding timing so that when attenuated light pulses 103 and corresponding portions of characteristic light 105 are incident to intensity modulator 440, electrical control pulses 415 of control signal 407 are incident to intensity modulator 440 to turn off intensity modulator 440, thus preventing output of attenuated light pulses 103 and the corresponding portions of characteristic light 105 to scanning interferometer 450. On the other hand, when electrical control pulses 415 of control signal 407 are not incident to intensity modulator 440 (regions 417), intensity modulator 440 is turned on to output portions of characteristic light 419 as shown in FIG. 10C to scanning interferometer 450 for detection. A detected signal 409 having increased signal to noise ratio may thus be output from scanning interferometer 450 responsive to the portions of characteristic light 419. In FIG. 10C, the dotted lines are indicative of attenuated light pulses 103 and the corresponding portions of characteristic light 105 that are not output to scanning interferometer for detection.

In the partial sampling of this representative embodiment, a same portion of characteristic light 419 between respective pairs of attenuated light pulses 103 shown in FIG. 10C are provided to scanning interferometer 450 for detection, in contrast to the entirety of the characteristic light 105 between respective pairs of attenuated light pulses 103. In a variation of this representative embodiment, a sampling window of the characteristic light 105 may be moved by changing the duration and/or timing of electrical control pulses 415 of control signal 407 shown in FIG. 10B, so that eventually the entirety of the characteristic light 105 may be output to scanning interferometer 450 for sampling. That is, different portions of characteristic light 105 between respective pairs of attenuated light pulses 103 may be provided to scanning interferometer 450 for detection. In this embodiment, the duration and/or timing of electrical control pulses 415 of control signal 407 may be changed by controller 485.

While specific embodiments are disclosed herein, many variations are possible, which remain within the concept and scope of the present teachings. For example, by broadening the control pulses of control signals 107, 207 and 307, optical spectrometers 10, 20 and 30 in FIGS. 2-4 may be configured for partial sampling with or without a movable sampling window. The control pulses may be broadened electronically with a triggerable pulse generator, or a triggerable time synthesizer, etc. Alternatively, the first light pulses provided to respective photodetectors 180, 280 and 380 may be broadened optically with dispersive elements such as an optical fiber, or a pair of prisms, or a pair of gratings, etc. The extent or size of the portion of the characteristic light output to the scanning interferometer for detection may be selectable by controlling the dispersion in the dispersive elements, and/or the pulse width of the control pulses output by the pulse generator or time synthesizer. Moreover, the corresponding part of the characteristic light output to the scanning interferometer for detection may be selectable by controlling the adjustable delay in optical spectrometers 10, 20 and 30 in FIGS. 2-4.

As a still further variation, the timing of the pulse train generated by pulsed light source 510 and the auxiliary light generated by auxiliary light source 532 may be manually adjusted during set up of optical spectrometer 50 shown in FIG. 6, so that controller 585 may be omitted. Also, the frequency components of the pulse train of FIG. 1A have been described as partially attenuated and/or phase shifted by molecules of the sample. It should however be understood that the attenuation and phase shift may be caused by quantum absorbers of the sample, such as atoms, ions, etc., for example. Such variations would be apparent in view of the specification, drawings and claims herein.

What is claimed is:

1. A method comprising:
passing light pulses through a sample to provide sample light, the sample light comprising attenuated light pulses, and characteristic light formed by interaction between the light pulses and sample molecules, wherein the characteristic light is located between the attenuated light pulses;
substantially removing the attenuated light pulses from the sample light; and
detecting the characteristic light from the sample light after removing the attenuated light pulses.

2. The method of claim 1, wherein the attenuated light pulses are removed from the sample light by an intensity modulator responsive to a control signal.

3. The method of claim 2, wherein a same portion of the characteristic light between respective pairs of attenuated light pulses are provided for said detecting responsive to the control signal.

4. The method of claim 2, wherein different portions of the characteristic light between respective pairs of attenuated light pulses as provided for said detection responsive to the control signal.

5. The method of claim 2, further comprising:
splitting a portion of each of the light pulses prior to passing the light pulses through the sample to provide first light pulses; and
generating the control signal responsive to the first light pulses.

6. The method of claim 5, further comprising adjustably delaying the first light pulses prior to generating the control signal.

7. The method of claim 5, further comprising adjustably delaying the sample light, or the light pulses prior to passing through the sample.

8. The method of claim 5, further comprising adjustably delaying the control signal.

9. The method of claim 2, further comprising generating the light pulses responsive to a drive signal, wherein the control signal is generated responsive to the drive signal.

10. The method of claim 1, wherein said removing the attenuated light pulses comprises:
converting the sample light to provide the characteristic light as light of a first frequency band, and the attenuated light pulses as light of a second frequency band; and
filtering the converted light to provide the light of the first frequency band for said detecting.

11. The method of claim 10, wherein said converting comprises:
mixing the characteristic light with auxiliary light to provide the light of the first frequency band, and
passing the attenuated light pulses without mixing to provide the light of the second frequency band.

12. The method of claim 11, wherein the auxiliary light is synchronized to be coincident with different portions of the characteristic light between respective pairs of attenuated light pulses.

13. The method of claim 11, wherein the auxiliary light is synchronized to be coincident with a same portion of the characteristic light between respective pairs of attenuated light pulses.

14. The method of claim 10, wherein said converting comprises:
mixing the attenuated light pulses with auxiliary light to provide the light of the second frequency band, and
passing the characteristic light without mixing to provide the light of the first frequency band.

15. The method of claim 10, wherein the characteristic light and the attenuated light pulses are converted by a non-linear optical crystal.

16. An optical spectrometer comprising:
an optical component configured to receive sample light comprising attenuated light pulses, and characteristic light formed by interaction between light pulses incident on a sample and sample molecules, wherein the characteristic light is located between the attenuated light pulses, the optical component further configured to substantially remove the attenuated light pulses from the sample light; and
a detector configured to detect the characteristic light from the sample light after removal of the attenuated light pulses.

17. The optical spectrometer of claim 16, wherein the optical component is configured to modulate the sample light to remove the attenuated light pulses responsive to a control signal.

18. The optical spectrometer of claim 17, wherein the optical component is configured to provide a same portion of the characteristic light between respective pairs of attenuated light pulses to said detector responsive to the control signal.

19. The optical spectrometer of claim 17, wherein the optical component is configured to provide different portions of the characteristic light between respective pairs of attenuated light pulses to said detector responsive to the control signal.

20. The optical spectrometer of claim 17, further comprising:
a beam splitter configured to split a portion of each of the light pulses into first light pulses; and
a second detector configured to generate the control signal responsive to the first light pulses.

21. The optical spectrometer of claim 20, further comprising an adjustable delay configured to delay the first light pulses provided to the second detector.

22. The optical spectrometer of claim 20, further comprising an adjustable delay configured to delay the sample light, or the light pulses provided to the sample.

23. The optical spectrometer of claim 20, further comprising an adjustable delay configured to delay the control signal.

24. The optical spectrometer of claim 17, further comprising a light source configured to generate the light pulses responsive to a drive signal, wherein the control signal is generated responsive to the drive signal.

25. The optical spectrometer of claim 16, wherein the optical component comprises:
a converter configured to convert the sample light to provide the characteristic light as light of a first frequency band, and the attenuated light pulses as light of a second frequency band; and
a filter configured to provide the light of the first frequency band to the detector.

26. The optical spectrometer of claim 25, wherein the converter is configured to mix the characteristic light with auxiliary light to provide the light of the first frequency band, and to pass the attenuated light pulses without mixing to provide the light of the second frequency band.

27. The optical spectrometer of claim 26, wherein the auxiliary light is synchronized to be coincident with different portions of the characteristic light between respective pairs of attenuated light pulses.

28. The optical spectrometer of claim 26, wherein the auxiliary light is synchronized to be coincident with a same portion of the characteristic light between respective pairs of attenuated light pulses.

29. The optical spectrometer of claim 25, wherein the converter is configured to mix the attenuated light pulses with auxiliary light to provide the light of the second frequency band, and to pass the characteristic light without mixing to provide the light of the first frequency band.

30. The optical spectrometer of claim 25, wherein the optical component comprises a non-linear optical crystal.
